(19) United States
(12) Patent Application Publication
(10) Pub. No.: US 2014/0332469 A2
(43) Pub. Date: Nov. 13, 2014

(54) METHOD AND SYSTEM FOR TREATING A LIQUID MEDIUM BY REVERSE OSMOSIS

(71) Applicant: Aqtion Pte Ltd, Singapore (SG)

(72) Inventor: Julia Navarsete, Longyearbyen (NO)

(21) Appl. No.: 13/741,059

(22) Filed: Jan. 14, 2013

Related U.S. Application Data
(60) Provisional application No. 61/656,352, filed on Jun. 6, 2012.

(51) Int. Cl. B01D 61/12; B01D 61/02

(52) U.S. Cl. CPC B01D 61/12; B01D 61/025
USPC 210/652; 210/143

(57) ABSTRACT

In a method for treating a liquid medium by reverse osmosis in a cyclic process, the pressure to the upstream side of the reverse osmosis membrane is generated by transferring the power of a basically free-falling weight to a hydraulic cylinder which generates the high pressure needed to overcome the osmotic pressure of the liquid medium.

The system performing the method uses a weight medium capable of travelling vertically between an initial and terminal position. The power thereby generated is transmitted to a hydraulic cylinder containing the liquid medium which is subjected to a high pressure and delivered to the upstream side of a reverse osmosis unit. At the end of the process cycle the weight medium is released from the weight vessel, and a following cycle is initiated, refilling the hydraulic cylinder with untreated liquid medium

### INTRODUCTION

This nonprovisional application claims the benefit under 35 U.S.C. §119(e) of U.S. Provisional Application No. 61/656,352 filed on Jun. 6, 2012 and under 35 U.S.C. §119(a) of Patent Application No. 20121260 filed in Norway on Oct. 25, 2012. The entire content of all the above applications is incorporated by reference.

The present invention concerns a method for treating a liquid medium by reverse osmosis in a cyclic process, the liquid medium being a solution, a dispersion or an emulsion or a combination thereof, as well as a system for performing the method of the invention, wherein the system comprises a reverse osmosis unit with a reverse osmosis membrane.

In many parts of the world there is a lack of sufficient fresh-water resources and with an increasing population this represents a serious and growing problem. The majority of countries with coastline to the ocean lacks sufficient drinking- and fresh-water resources, but the oceans contain 97% of all water on the planet, and thus great efforts have been made to cover the need for fresh water for drinking and irrigation in agriculture by using desalination units for converting saline water or sea water to fresh water. Present-day desalination units require extremely large amounts of energy as they are based on methods for desalination which are very energy-consuming This is particularly the case of multistage flash distillation units.

Since the 1990ies desalination units based on reverse osmosis for converting sea water to fresh water have increasingly come into use. Desalination units based on reverse osmosis require less energy than units based on conventional distillation methods, but the reverse osmosis itself demands a very high pressure in the filtration stage.

### Reverse Osmosis

Reverse osmosis is a membrane-based filtration method capable of removing many types of large molecules and ions from a solution by applying pressure to the solution on the upstream side of a selective membrane. As a result the solutes are retained on the pressurized upstream side of the membrane and the pure solvent passes through the membrane to the other side. The selectivity of a reverse osmosis membrane is such that large molecules or ions shall not pass through pores or holes in the membrane, but that a smaller component of the solution, such as the solvent, passes freely therethrough.

In a normal osmosis process the solvent naturally moves from an area of low solute concentration (high potential) through the membrane to a volume of high solute concentration (low potential). The movement of a pure solvent to equalize solid concentration on each side of the osmotic membrane generates an osmotic pressure. When an external pressure is applied to reverse the natural flow of the pure solvent, this is termed reverse osmosis. This process is similar to other membrane-technology applications, but there are essential differences between reverse osmosis and filtration. The removal mechanism in membrane filtration is draining or size exclusion and a filtration process is thus theoretically able to allow perfect exclusion of particles regardless of operational parameters such as the upstream pressure and concentration. Reverse osmosis is a diffusive mechanism and the separation efficiency is dependent on solute concentration, pressure and water flow rate.

### PRIOR ART

As well known, reverse osmosis is today used extensively for producing drinking water from sea water by removing salt and other substances thereof from the water molecules. A usual prior art scheme for reverse osmosis is shown in FIG. 1 where flow directions are indicated by arrows adjacent to the piping. A liquid medium to be treated, in this case regarded as sea water, is conveyed by a high-pressure pump which delivers pressurized sea water to the upstream side of the membrane in a reverse osmosis unit. The high pressure of the concentration generated by the high-pressure pump forces the water molecules through the membrane of the reverse osmosis unit and produces fresh (desalinated) water on the downstream side. The remaining high-pressure concentrate flows from the reverse osmosis unit via a pressure exchanger where concentrate is drained from the concentrate flow and sea water is fed from the intake. The content of the high-pressure exchanger is conveyed by a circulation pump to the high-pressure section of the system.

A reverse osmosis requires that high pressure is exerted on the upstream side of the membrane and this pressure will usually be between 2 and 17 bar for fresh and brackish water and as high as 40 to 82 bar for sea water. This is because sea water has a natural osmotic pressure of 27 bar which must be overcome. Reverse osmosis has been applied for desalination of sea water and the production of fresh water for many years, but has also increasingly been applied for purifying fresh water for medical, industrial and domestic applications. It should be mentioned that reverse osmosis is eminently capable of moving particles from a liquid medium down to a size of about 0.1 nm. Reverse osmosis can thus be regarded as a hyper-filtration version of membrane filtration. Large-size reverse osmosis units are now in use for desalination of sea water or generally for purification of water in a number of environments. Reverse osmosis is also applied for cleaning effluent and brackish groundwater which then usually are treated in an ordinary effluent treatment plant before being subjected to reverse osmosis treatment. Reverse osmosis is also used for production of deionized water and in the food-processing industry and even used in the wine industry. A great advantage of the reverse osmosis process is that it does not require thermal energy. This makes it desirable in processes where conventional heat-treatment processes can be expensive and also detrimental for certain heat-sensitive substances, such as may be found in food products.

The efficiency of the reverse osmosis process depends on a number of factors including membrane sizes and membrane pore sizes, the temperature of the liquid medium and the membrane surface area. But the overall determining factor is the pressure applied to the upstream side of the reverse osmosis membrane. The pressure applied depends on the osmotic pressure of the liquid medium, which in case of sea water is around 27 bar. To operate a reverse osmosis unit the pressure applied to the upstream side should be at least twice as high and usually at least 40 bar and upwards to beyond 100 bar is applied. Portable reverse osmosis unit for domestic use are widely used in private households in many parts of the world, but they are usually operating below 40 bar and thus less efficient. But the yield requirement is not critical under such circumstances.

Typically the high-pressure pumps used in desalination of sea water under industrial conditions generate pressures from about 55 to above 80 bar, but require a large amount energy. The efficiency of small domestic portable units is low as they operate at a very low pressure and are usually not able to achieve a yield of more than 15 to 20% of the water entering the system. Large-scale industrial and public systems based on reverse osmosis have typically a production efficiency about 75% or even as high as 90%. They operate continuously apart from a few hours each day spent for maintenance, but yet such large plants are capable of outputting fresh water in amounts of more than 1000 m³ per unit and day. The main disadvantage with prior art reverse osmosis systems is the high energy costs. As a matter of fact the dominant cost factor is the energy consumption. It is thus desirable to furnish a reverse osmosis unit which lowers the energy consumption significantly, yet contributes a high efficiency.

### OBJECTS OF THE INVENTION

A first object of the invention is to provide a method for reverse osmosis capable of reducing the energy consumption by a significant factor and lowering the cost per unit purified liquid produced.

Another object of the invention is to provide a method and a system for reverse osmosis processes which can be applied in a variety of environments and circumstances and is easy to set up and locate and moreover can be scaled according to need with quite simple measures.

The objects of the invention as well as other advantages are achieved with a method according to the introduction of the claim 1 and the system according to the introduction of claim 7.

In addition some advantageous applications will be apparent from the claims of use attached hereto.

### DRAWING FIGURES

The invention will be better understood from the following description with reference to the appended figures of which

FIG. 1 shows a prior art reverse osmosis system using a pressure exchanger, as already discussed in the introduction,

FIG. 2 a flow diagram of the system according to the present invention,

FIG. 3 a schematic side view of the system at the start of a process cycle,

FIG. 4 a schematic side view of the system at the end of a process cycle,

FIG. 5 a side view of how the components of the system are provided in more practical layout,

FIG. 6 a schematic view from above showing the position of components in the system similar to that in FIG. 5, in section, and

FIG. 7 a schematic section through a hydraulic cylinder and power transmission as used with the system according to the present invention.

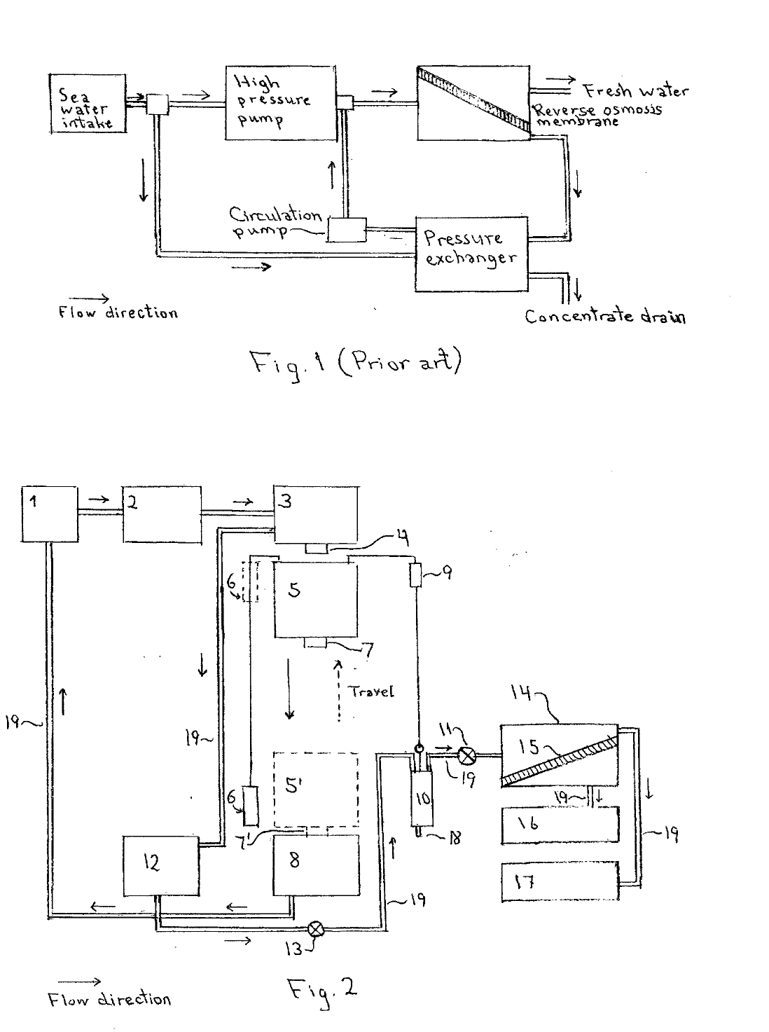

### DESCRIPTION OF THE INVENTION

The method and the system according to the invention shall now be described in greater detail with reference to the appended drawing figures. The method as such will be better understood by a thorough discussion of the flow diagram of the system as shown in FIG. 2, which shows a preferred embodiment of the system according to the invention.

A liquid medium intake 1 is connected to a pump 2 which transports a liquid medium to a feed vessel 3. In this particular embodiment the feed vessel 3 is connected to a weight vessel 5. In a preferred embodiment the weight vessel 5 is provided beneath the feed vessel 3 and mounted moveable in a here not shown frame. The feed vessel 3 is then positioned above the weight vessel 5 and can deliver the liquid medium through the closable outlet 4 to the weight vessel 5. The liquid medium itself is thus used as the weight medium of the weight vessel 5. The weight vessel 5 is capable of being moved between an initial position and a terminal position essentially in free fall, as indicated in FIG. 2, where the terminal position is indicated by stitched lines. When mounted in a frame the weight vessel 5 is provided with guiding means engaging guides in the mounting frame for stabilizing the vertical downwards motion. When being filled with liquid medium from the feed vessel 3 the weight vessel 5 is locked in its initial position. When it is filled, the locking means are released. The weight vessel 5 then drops to its terminal position where the weight medium may be discharged via closable outlet 7, e.g. to an effluent tank 8. After the weight vessel 5 has been emptied, it can be returned from its terminal position to its initial position by one or more movable counterweights 6 running through suitable means mounted in the frame. The counterweights 6 must of course be heavier than the empty weight vessel 5 in order that it shall be returned to its initial position. A power transmission 9 is attached to the weight vessel 5 for transmitting the power generated by its downward vertical movement to a hydraulic cylinder 10.

A preferred embodiment of the hydraulic cylinder and the power transmission shall be given below. It is of course to be understood that there can be more than one hydraulic cylinder 10 provided in the system with a corresponding number of power transmissions. Liquid medium is also conveyed from the feed vessel 3 to a pre-filtration unit 12, most simply by gravity and then the liquid medium is passed through a flashback valve 13 to the top of the hydraulic cylinder 10. The hydraulic cylinder 10 is set to a first or starting position due to the pressure exerted by the head of the feed water. This implies that the hydraulic cylinder 10 should be positioned at some distance below the feed vessel 3 in order to generate a suitable head. For heads below 10 m the pressure of the liquid medium in hydraulic cylinder 10 will of course be less than 1 bar. The flashback valve 13 closes when the maximum pressure given by this head has been attained in the hydraulic cylinder 10. The process cycle will now continue when the weight vessel 5 has been completely filled, released from the locking means and falling towards its terminal position. The force of the falling weight vessel 5 of course corresponds to its total mass times acceleration of gravity and this force is during the fall transmitted via the power transmission 9 to the hydraulic cylinder 10 which thus is actuated in a manner that increases the pressure of the liquid medium therein. The pressure in the hydraulic cylinder 10 will reach a maximum when the weight vessel has reached its terminal position, and will in any case attain a value high enough to ensure a pressure sufficient for an efficient reverse osmosis process. At a preset pressure a flashback valve 11 opens and admits the pressurized liquid medium into the reverse osmosis unit 14 at the upstream side of the reverse osmosis membrane 15. The flashback valve 11 can for instance be set to open when the pressure in the hydraulic cylinder has reached 60 bar, which is the low end for effecting efficient reverse osmosis of sea water which has an osmotic pressure of 27 bar, as mentioned in the introduction.

The energy created by the travel of the weight vessel 5 will be continually transmitted to the hydraulic cylinder 10 during its travel and forcing the liquid medium out of the hydraulic cylinder 10 through the flashback valve 11 when it opens and into the reverse osmosis unit. When the hydraulic cylinder 10 is emptied, the flashback valve 11 closes. The weight vessel 5 has terminated its downwards motion and can be emptied of the weight medium, for instance to the optional effluent tank 8, where the weight medium can be circulated back via the liquid medium intake 1 and the pump 2 to the feed vessel 3. The feed vessel is all the time fed with liquid medium via the pump 2 to ensure an as smooth operation as possible. When the weight vessel is returned to its initial position, the closable outlet 4 from the feed vessel 3 is opened and the filling of the weight vessel 5 with the weight medium starts all over again. At the same time the flashback valve 13 also opens and admits water flowing freely under its own gravity from the feed vessel 3 and into the hydraulic cylinder 10. The latter has an air vent 18 at the bottom to let air escape during the filling process. When the pressure of the liquid medium in the hydraulic cylinder has attained a value corresponding to the head between the feed vessel and the hydraulic cylinder, the flashback valve 13 closes, and the now filled weight vessel 5 can be released to continue another cycle. In the reverse osmosis filter unit 14 the liquid medium, for instance sea water, is separated into a highly concentrated saline solution and fresh water emerges at the downstream side of the reverse osmosis membrane 15. A vessel 16 is provided for receiving the purified liquid medium or fresh water from the downstream side of the reverse osmosis unit 14, and a vessel 17 for receiving the highly concentrated saline solution from the upstream side of the reverse osmosis membrane 14 can also be provided.

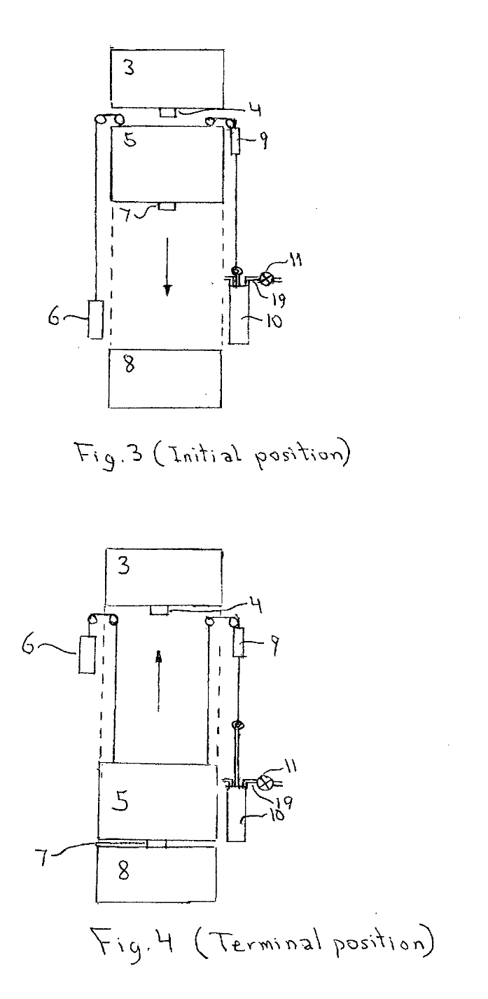

FIG. 3 shows a simplified side view of the reverse osmosis system according to the present invention. The feed vessel 3 is mounted atop a not shown frame containing the weight vessel 5. The weight vessel 5 is locked in an initial position in the frame by releasable locking means (not shown) Filling weight medium from the feed vessel 3 to the weight vessel 5 takes place via a closable outlet 4 in the feed vessel 3 and can proceed fairly swiftly depending on the capacity of the weight vessel 5. The counterweight 6 is in its bottom position, and the hydraulic cylinder 10 is shown where it will be located, upright from the bottom of the not shown frame. The connected flashback valve 11 is closed. It is of course to be understood that there can be more than one counterweight and more than one hydraulic cylinder. In any case the total weight of a counterweight 6 or the total weight of counterweights 6 should exceed the weight of the empty weight vessel 5 in order to secure its return from the terminal to the initial position.

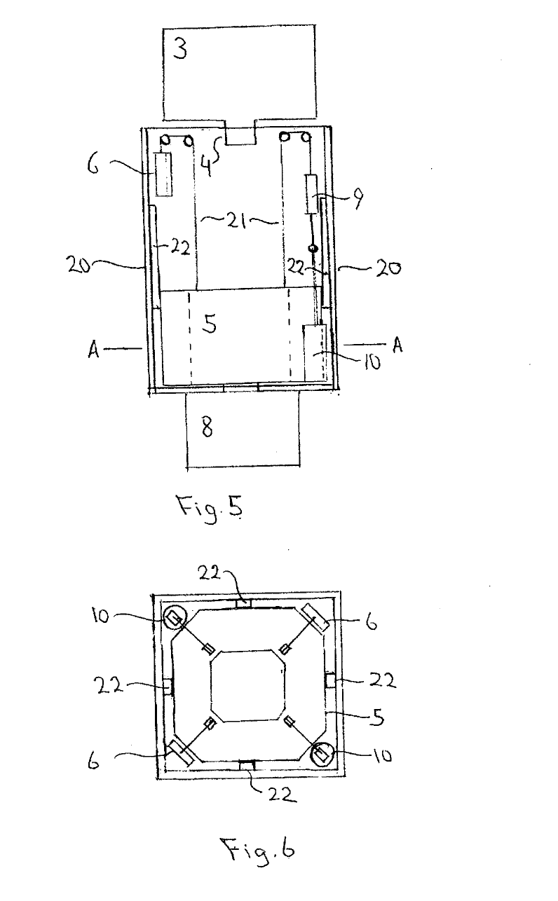

In the side view shown in which FIG. 4 is essentially similar to FIG. 3, the weight tank 5 is shown in its terminal position at the bottom of a not shown frame. The counterweight 6 or one of the counterweights 6 has as shown been moved upwards towards the top of the not shown frame. The liquid medium in the hydraulic cylinder 10 has been pressurized during the travel of the weight vessel 5, at least for most of the time, and will when the weight vessel 5 has reached its terminal position, release the pressurized liquid medium through the flashback valve 11. The counterweight 6 then returns to the weight vessel 5 to the position shown in FIG. 3 and another process cycle can start.

FIG. 5 is a side view of parts of the liquid osmosis system according to the invention with the weight vessel 5 in its terminal position. Likewise is the position of a counterweight 6 is shown and the hydraulic cylinder 10 is now pressurized via the power transmission 9. Connecting and lifting wires for the counterweight 6 and the power transmission 9 are shown as 21. Guides 22 for the weight vessel are indicated,

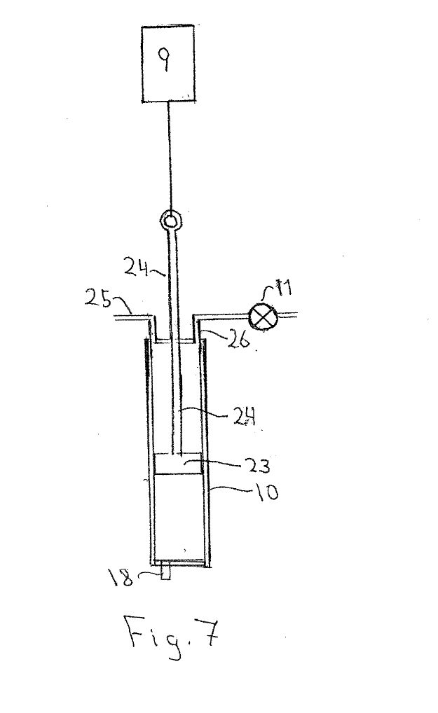

FIG. 6 shows a cross section A-A of the system in the position in FIG. 5. Two counterweights 6 are mounted in the frame 20 at the corners thereof. Two hydraulic cylinders 10 with connected power transmissions 9 are mounted at opposite corners thereof. Wire connections 21 for the counterweights 6 and the power transmissions 9 are indicated. Guides 22 are shown mounted on each side surface of the weight vessel 5.

FIG. 7 shows an arrangement of the hydraulic cylinder 10. It comprises a piston consisting of a piston head 23 and a piston rod 24. At the beginning of a process cycle as shown in FIG. 6 the piston head 23 is in a first position at the top of the cylinder 10. At the top of the cylinder 10 there is provided an inlet 25 for the gravity flow from the feed vessel 3 via the pre-filtration unit 12 and flashback valve 13 which of course now is open. At the outlet 26 on the top of the hydraulic cylinder 10 the flashback valve 11 is closed. The head between the feed vessel 3 and top of the cylinder 10 will force the piston 20 backwards to a second position when it rests at the bottom of the hydraulic cylinder 10. The pressure of the liquid medium in the hydraulic cylinder 10 now corresponds to the head between the hydraulic cylinder and the feed vessel 3 and the flashback valve 13 closes and will of course remain closed when the pressure in the hydraulic cylinder 10 increases as the weight vessel 5 moves downwards. The power transmission 9 is preferably a block and tackle arrangement which imparts the power generated by the falling weight vessel 5 to the piston rod 24 of the hydraulic cylinder in tension by engaging the free end of the piston rod, thus forcing the piston head 23 upwards in the cylinder 10 and pressurizing the liquid medium therein. As soon as the pressure of the liquid medium in the hydraulic cylinder 10 has reached a prescribed value, for instance typically 60 bar or more, the flashback valve 11 opens and the pressurized liquid medium flows out of the hydraulic cylinder 10 at outlet 26 as the piston head 23 continues upwards in the hydraulic cylinder 10. The pressure increases, but with the hydraulic cylinder 10 empty and the reverse osmosis ongoing in the reverse osmosis unit 14 the pressure eventually falls, the flashback valve 11 closes and the flashback valve 13 once more opens for feeding liquid medium from the feed vessel 3 to the hydraulic cylinder 10. As will be seen, the method and system according to the present invention takes place with the only energy actually being consumed is that used by the feed pump 2 The energy needed for generating the high pressure to the reverse osmosis unit is created by the gravitational potential of the filled weight vessel 5 in the initial position as shown in FIG. 3. The energy consumed by the feed pump is needed for lifting liquid from the intake 1 wherever it is positioned, to the feed vessel 3 and further to the weight vessel 5. It should be noted that although the movement of the weight vessel 5 from the initial position to its terminal position is termed as a basically free fall, friction loss and the impedance of the system in reality work against the gravity and this means that the weight vessel 5 will move downwards rather slowly. As easily realized, the whole process is cyclic as opposed to the continuous operation of reverse osmosis systems with high-pressure pumps.

As will be seen from the above description, the method and system according to the invention is based on gravity for generating the required high pressure needed for a reverse osmosis process. The additional energy input is that required for feeding the liquid medium to the feed vessel and in case also to the weight vessel. The following theoretical considerations can be made regarding the relationship between parameters such as the mass m of the filled weight vessel, and the energy generated in the free fall. In other words one has the relationship

$$P = \frac{m \cdot g \cdot k}{A}$$

where P is the generated pressure in the hydraulic cylinder, m the mass of the filled weight vessel, g the acceleration of gravity and k the transmission factor, with A being the free cross-sectional area of the hydraulic cylinder. Based on an experimental prototype with m=7000 kg, using a block and tackle transmission with a transmission factor of 4 a so-called double tackle, a cross-sectional area of the hydraulic cylinder can easily be calculated for a pressure of 60 bar, i.e. 6 MPa per m². Inserting these values in the equation and solving for A one finds that A must be about 458 cm². The capacity of this system in one process cycle is given as V=A.1 where V is the free volume of the hydraulic cylinder A, again the free cross-sectional area thereof and l the stroke length of the piston.

For persons skilled in the art of hydraulics it is easy realized that the stroke length for a given travel distance of the weight tank will depend on the transmission factor. Using the transmission factor selected as above, it follows that for a travel distance of 6 m the stroke length of the piston in the hydraulic cylinder will be 1.5 m. Applying these values to the equation above, the free volume of the hydraulic cylinder then becomes about 69 l, which will be the throughput capacity in one cycle. The output will then be 30-40 l of purified liquid medium per cycle. Conservatively setting this to 30 l pro cycle and assuming (the assumption must be based on empirical evidence) that a total cycle period is 120 s, it will be seen that a system with these parameters is capable of producing close to 1 m³ or 1000 l of purified water per hour. Assuming some downtime for maintenance, a system as described above will be able to generate at least 20 m³ of fresh water per day in a desalination process.

The following table shows five numerical examples for attainable pressures for a weight vessel with a total mass m of 7200 kg when filled with the weight medium, for given total free area A.n of the cylinder or cylinders and stroke lengths l, the free volume V and the attainable pressure P.

TABLE

| | m (kg) | A.n (cm²) | l (cm) | V(l) | P(bar) |
|---|---|---|---|---|---|
| 1 | 7200 | 270 | 270 | 63.45 | 60 |
| 2 | 7200 | 188 | 135 | 25.40 | 150 |
| 3 | 7200 | 1412 | 135 | 190.60 | 20 |
| 4 | 7200 | 56 | 135 | 7.60 | 500 |
| 5 | 7200 | 18 | 135 | 2.54 | 1500 |

Given the fairly long period of a process cycle the volume capacities may not appear impressive, although it is seen that it is possible to achieve a pressure as high as 1500 bars within a reasonable range of other parameters. The yield per cycle will vary with the pressure and be about 50% for a pressure of 60 bar and increasingly much higher. A pressure of 20 bar is actually too low to be used for desalination of sea water, but could be adapted for purifying natural fresh water or even brackish water with a satisfactory yield, i.e. about 30 l per cycle or 15%. As mentioned, the osmotic pressure of fresh water is about 3 bar, and brackish water has typically an osmotic pressure of 5 to 15 bar.

However, it should be borne in mind that the system according to the present invention lends itself eminently to scalability. There are no structural barriers to e.g. increasing travel length of the weight vessel considerably and also to increase the mass of the filled weight vessel to appreciably more than the about 7200 kg in the example above. This means that capacities and yields can be significantly improved. Still the drawback may be the fairly long period of a cycle in a cyclic process, but this is more than offset by the simplicity of the system combined with very low energy consumption. Since the energy consumption is mainly limited to the required pump power of the feed pump, it will be seen that e.g. lifting 7000 kg of sea water 10 m and having volume capacity of about 68.7 l, a travel distance of the weight vessel of 6 m and a generated pressure in the hydraulic cylinder of 60 bar, in as mentioned long cycle time of about 2 min and a yield at this pressure of about 45%, one would expect the system to produce about 900 l per hour i.e. close to 1 m³. The long cycle period is of about 2 min is of course a consequence of filter impedance and resistance in the hydraulic cylinder. In addition there may be some loss in the power transmission, albeit small However, by increasing the travel distance and the mass of the weight vessel by a factor of two it is seen that the capacity will be increased fourfold and the yield of the system can now be increased correspondingly. In a 20 hours working period it will be possible to produce about 75 m³ of fresh water in a desalination process. Another doubling and the output will increase to 300 m³ per day. The installation will then appear as a column about 30 m high with vessel capacities in the range of several tens of m.sup.3. Further examples showing the effect of scaling with estimations of output and costs for 1 m.sup.3 of desalinated sea water is given in appendix 1

A very large installation must necessarily be non-movable, but smaller units could be mounted on vehicles and easily moved about to suitable locations. It is seen that an industrial-scale installation with a capacity of about 300 m³ of fresh water per day has a capacity of several present-day installations considered large. However a bank of such units can be envisaged providing industrial scale plant for fresh water production ranging into several thousand m³ per day.

As stated above, the only essential energy requirement will be that for the feed pump and the requirement can be easily calculated by considering the mass of the weight medium to be lifted to the top of the weight vessel and the lifting distance involved. Lifting 7000 kg of water 10 m in about 100 s implies a power consumption of 7000 W corresponding to an energy consumption of 170 kWh per day. Assuming some loss in the pumping system this probably adds up to 200 kWh per day, which at for instance at current electricity prices in the cost in Norway would amount to 60 NOK per day or less than 8 Euros. The output could be more than 30 m² per day (1620 l per hour). Thus the energy costs per m.sup.3 fresh water produced will be less than 2 NOK per day. Considering the costs of a bottle of drinking water in a grocery store, this amount appears insignificant.

As evident from the discussion of the reverse osmosis process in the introduction, the method and system according to the invention is not necessarily limited to desalination of sea water, but can be used to hyperfiltrate dispersions or emulsions, preferably after they have been subjected to prefiltration to remove the larger constituent particles. However, the present invention can also be applied to purify natural water, i.e. natural fresh water in industrial processes and the like where a high purity is required. This means of course that one no longer is dependent on locating the units close to sea or saltwater, but that they can be placed in arbitrary locations. It is then of course also possible to supply natural fresh water by locating the system in a location where topography allows for a natural head. Since the osmotic pressure of a fresh water is very low, just a couple of bar, this means that a high pressure differential can be attained within the scope of the present invention and thus providing for very high yield from the reverse osmosis unit when applied for treating fresh water.

It should be mentioned that reverse osmosis produces a highly purified product. As most minerals and the like are removed, the product becomes acidic and some post-treatment may be required, for instance remineralization.

On a final note, it should be observed that increasing the capacities and providing for a higher pressure generated in the hydraulic cylinder, it will be possible to increase the yields considerably and making the system of the present invention able to compete with present-day systems applied with high-pressure pumps which have yields in the range of 70-90%.

1. A method for treating a liquid medium by reverse osmosis in a cyclic process, the liquid medium being a solution, a dispersion or an emulsion or a combination thereof, wherein the method comprises
providing a weight vessel adapted for moving vertically between an initial position to a terminal position in a basically free fall and being returned to the initial position, feeding means connected with a hydraulic cylinder with a piston means and optionally with the weight vessel in the initial position of the latter, and a power transmission connecting the movable weight vessel with the hydraulic cylinder, and a reverse osmosis unit connectable with the hydraulic cylinder, and wherein a process cycle comprises steps for
a) the conveying liquid medium to the hydraulic cylinder and forcing the piston means to a first position where the hydraulic cylinder is filled with the liquid medium,
b) locking the weight vessel in its initial position,
c) filling the weight vessel with a weight medium,
d) releasing the weight vessel with a prescribed amount of the weight medium, allowing it to travel from its initial position to its terminal position,
e) transmitting the power generated by the travel of the weight vessel to the piston means of the hydraulic cylinder, whereby a pressure substantially higher than the osmotic pressure of the liquid medium is imparted thereto,
f) conveying the liquid medium when a specified pressure thereof has been attained to the upstream side of a membrane in the reverse osmosis unit,
g) separating the liquid medium in two components, one of which passes through the reverse osmosis membrane and emerges on a downstream side thereof purified of solutes, dispersed or emulsified matter depending on the initial composition of the liquid medium, and
h) returning the weight vessel to its initial position and terminating a cycle when the hydraulic cylinder with the piston in a second position is emptied of liquid medium, whereafter a following cycle is initiated by repeating steps a)-h).

2. A method according to claim 1,
wherein the liquid medium and the weight medium being one and the same.

3. A method according to a claim 2,
wherein providing the feed means as a feed vessel atop the weight vessel and continuously conveying a liquid medium thereto for simultaneously filling the weight vessel and the hydraulic cylinder with the liquid medium.

4. A method according to claim 1,
wherein emptying the weight vessel of the weight medium in its terminal position and returning the empty weight vessel to its initial position by movable counterweights attached thereto.

5. A method according to claim 1,
wherein the liquid medium being a saline solution.

6. A method according to claim 5,
wherein the saline solution being sea water.

7. A system for performing the method according to claim 1,
wherein the system comprises a reverse osmosis unit with a reverse osmosis membrane, wherein comprising a feed means for receiving a liquid medium, a weight vessel adapted for travelling vertically between an initial position and a terminal position under its own weight and basically in free fall, at least one hydraulic cylinder with a piston means and connected to the feed means and the reverse osmosis unit respectively, a power transmission connected between the weight vessel and the at least one hydraulic cylinder for transmitting the power generated by the travel of the weight vessel to the at least one hydraulic cylinder, and piping providing connections between the feed means, the hydraulic cylinder and the reverse osmosis unit.

8. A system according to claim 7,
wherein the feed means is a feed vessel mounted above the weight vessel and connected thereto for feeding the liquid medium to the weight vessel via a closable connection when the weight vessel is locked in the initial position, and comprising emptying means at the bottom of the weight vessel for emptying the liquid medium when the weight vessel has reached its terminal position.

9. A system according to claim 7,
wherein the weight vessel comprising releasable locking means, locking the vessel in its initial position when being filled with its medium.

10. A system according to claim 7,
wherein the weight vessel is mounted in a frame and provided with guides engaging corresponding guides mounted in the frame.

11. A system according to claim 10,
wherein the system comprises one or more moveable counterweights attached to the weight vessel and secured at the top of the frame for returning in the empty weight vessel from its terminal position to its initial position.

12. A system according to claim 7,
wherein the at least one power transmission is a block and tackle means, connected to the weight vessel and the piston means of a respective hydraulic cylinder.

13. A system according to claim 7,
wherein comprising a flashback valve in the piping connection between the feed means and the at least one hydraulic cylinder and adapted for terminating the connection when the at least one hydraulic cylinder is filled with liquid medium.

14. A system according to claim 7,
wherein comprising a flashback valve in the piping connection between the hydraulic cylinder and the reverse osmosis unit and adapted to open the connection when a predetermined pressure has been reached in the liquid medium in the hydraulic cylinder.

15. A system according to claim 7,
wherein comprising a pump for conveying liquid medium to the feed means.

16. A system according to claim 7,
wherein comprising a prefiltration unit connected between the feed means and the at least one hydraulic cylinder.

17. A system according to claim 7,
wherein the hydraulic cylinder is provided and secured in a vertical position preferably at the level of the weight vessel in its terminal position.

18. A system according to claim 7,
wherein the output capacity of the reverse osmosis unit is scalable by adjusting one or more of the following parameters of the system, namely the mass of the filled weight vessel, the travel distance of the weight vessel, the transmission ratio of the power transmission and the cross-sectional free area of the at least one hydraulic cylinder.

19. The system according to claim 7 wherein the system is used for desalination of sea water.

20. The system according to claim 7 wherein the system is used for treatment of waste water.

21. The system according to claim 7 wherein the system is used for treatment of fresh water for industrial and domestic purposes.
